(19) United States
(12) Patent Application Publication
(10) Pub. No.: US 2013/0033354 A1
(43) Pub. Date: Feb. 7, 2013

(54) FERRITE POWDER OF METAL, FERRITE MATERIAL COMPRISING THE SAME, AND MULTILAYERED CHIP COMPONENTS COMPRISING FERRITE LAYER USING THE FERRITE MATERIAL

(71) Applicants: Sung Yong An, Gyeonggi-do (KR); Myeong Gi Kim, Gyeonggi-do (KR); Ic Seob Kim, Gyeonggi-do (KR)

(72) Inventors: Sung Yong An, Gyeonggi-do (KR); Myeong Gi Kim, Gyeonggi-do (KR); Ic Seob Kim, Gyeonggi-do (KR)

(21) Appl. No.: 13/564,454

(22) Filed: Aug. 1, 2012

(30) Foreign Application Priority Data
Aug. 1, 2011 (KR) 10-2011-0076555

(51) Int. Cl. H01F 27/255; H01F 1/01

(52) U.S. Cl. 336/233; 252/62.55; 252/62.56; 252/62.58; 252/62.59; 252/62.64

(57) ABSTRACT

Disclosed herein are a ferrite powder having a core-shell structure, the core being made of iron (Fe) or iron-based compounds comprising iron (Fe) and the shell being made of metal oxides, a ferrite material comprising the ferrite powder and the glass, and multilayered chip components including the ferrite layer using the ferrite material, inner electrodes, and outer electrodes. According to the exemplary embodiments of the present invention, it is possible to provide the ferrite material capable of improving the change in the inductance L value in response to applied current by suppressing magnetization at high current. The multilayered chip components including the ferrite material according to the exemplary embodiment of the present invention can also be used in a band of MHz.

### CROSS REFERENCE(S) TO RELATED APPLICATIONS

This application claims the benefit under 35 U.S.C. Section 119 of Korean Patent Application Serial No. 10-2011-0076555, entitled “Ferrite Powder of Metal, Ferrite Material Comprising the Same, and Multilayered Chip Components Comprising Ferrite Layer Using the Ferrite Material” filed on Aug. 1, 2011, which is hereby incorporated by reference in its entirety into this application.

### BACKGROUND OF THE INVENTION

1. Technical Field

The present invention relates to a ferrite powder of metal, a ferrite material comprising the same, and multilayered chip components comprising a ferrite layer using the ferrite material.

2. Description of the Related Art

A multilayered power inductor that is one of the multilayered chip components has been mainly used for a power supply circuit such as DC-DC converters within portable devices. Meanwhile, the multilayered power inductor has been developed to implement high current, low DC resistance, and the like, while being miniaturized. As a demand for high frequency and miniaturization of the DC-DC converter is increased, the use of the multilayered power inductor has been suddenly increased, instead of the existing wound choke coil.

The multilayered power inductor may be operated at high current while suppressing magnetic saturation of the inductor in terms of a material and a structure. As compared with the wound power inductor, the multilayered power inductor has a value of inductance L that is greatly changed in response to applied current but may be manufactured in a small size and may have a thin thickness. In addition, the multilayered power inductor is advantageous in DC resistance.

Generally, the power inductor needs to have the reduced change in an inductance value to used current. In particular, the power inductor being operated even at a low temperature of −55° C. to +a high temperature of +125° C. while having the reduced change in an inductance value to temperature has been gradually demanded.

Next, FIG. 1 shows the change in an inductance value of the multilayered power inductor and the wound power inductor in response to applied current.

It can be appreciated from FIG. 1 that the change in the inductance L value of the wound power inductor in response to applied current is smaller than that of the multilayered power inductor. Therefore, even in the multilayered power inductor, an attempt to implement the above matters has been conducted.

To this end, compositions and fine structures of materials, a structure design, and the like, are rendered as important factors. In other words, the multilayered power inductor may have the increased change in the inductance L value in response to the applied current, as compared with the wound power inductor. The reason is that the wound power inductor structurally has a large open magnetic circuit effect.

Therefore, in the multilayered power inductor, it is important to improve characteristics of the change in the inductance L value in response to the applied current. Today, a magnetic flux is broken using a non-ferrite gap layer partially included in an internal structure thereof, thereby improving the characteristics of the change in the inductance L value in response to the applied current.

Meanwhile, FIG. 2 shows the change in the inductance value of the multilayered power inductor using materials having high saturation magnetization (high Ms) and the multilayered power inductor using materials having low saturation magnetization (low Ms) in response to the applied current. Next, as can be appreciated from results of FIG. 2, in order to improve the characteristics of the change in the inductance L value according to the applied current, it is advantageous to use materials having a large saturation magnetization value.

In conclusion, in order to improve DC-bias characteristics of the multilayered power inductor, it is preferable to form the gap layer and use body materials having a large saturation magnetization value. Currently, the body materials used for the multilayered power inductor are generally NiZnCu ferrite and the gap layer uses non-ferrite materials. In the NiZnCu ferrite, the saturation magnetization value is controlled by controlling the content of Ni, Zn, and Cu but it is difficult for the saturation magnetization value to exceed 80 emu/g.

Next, FIG. 3 shows a general structure of the multilayered power inductor, wherein the multilayered power inductor is manufactured by a ferrite sheet and as a material of a body 20 in which an inner electrode 10 is formed, the NiZnCu having ferri-magnetism is used.

As a material of the gap layer 30, a non-magnetic ferrite (generally, ZnCu ferrite) having the ferri-magnetism is used and a front sheet gap or an open sheet gap is used. The gap layer 30 is inserted into the body 20 to block a magnetic flux, which serves to reduce the change in the inductance value in response to the applied current. The gap layer is fired at about 900° C. and then, an outer electrode 40 is formed and a plating layer 50 is formed using Ni, Sn, and the like, thereby finally manufacturing the multilayered power inductor.

However, the multilayered power inductor as shown in FIG. 3 has the following problems.

(1) The saturation magnetization value of the currently used NiZnCu ferrite is too value and thus, the value of the change rate in inductance after external current is applied is suddenly reduced. A solution to the above problem uses the materials having the large saturation magnetization value. However, even though compositions of NiO, ZnO, CuO, and Fe₂O₃ in the NiZnCu ferrite are slightly changed, the saturation magnetization value cannot be increased indefinitely and thus, has a theoretical limitation.

(2) The currently used NiZnCu ferrite breaks the magnetic flux using the non-ferrite gap layer partially included in the internal structure thereof to improve the characteristics of the change in the inductance L value in response to the applied current, such that a process may be complicated and incidental problems due to the insertion of the gap layer may occur.

### SUMMARY OF THE INVENTION

An object of the present invention is to provide a ferrite powder that can be used as ferrite materials of multilayered chip components.

In addition, another object of the present invention is to provide a ferrite material having a large saturation magnetization value, comprising a ferrite powder, capable of reducing a change rate in inductance after external current is applied.

Further, still another object of the present invention is to provide multilayered chip components comprising a ferrite material and isolating glass as a gap layer.

According to an exemplary embodiment of the present invention, there is provided a ferrite powder having a core-shell structure, wherein the core is made of iron (Fe) or iron-based compounds comprising iron (Fe) and the shell is made of metal oxides.

The metal oxides may be one or more selected from the group consisting of TiO₂, SiO₂, ZrO₂, SnO₂, NiO, ZnO, CuO, CoO, MnO, MgO, Al₂O₃, Cr₂O₃, Fe₂O₃, B₂O₃, and Bi₂O₃, but not be limited thereto.

The core may be made of a content of 95 mol % of Fe metal and the shell may be made of the rest.

According to another exemplary embodiment of the present invention, there is provided a ferrite material including: a ferrite powder having a core-shell structure, the core being made of iron (Fe) or iron-based compounds comprising iron (Fe) and the shell being made of metal oxides; and glass.

The glass may have a softening temperature Ts of 400 to 900° C.

The ferrite material may include 5 to 25 parts by weight of the glass for 100 parts by weight of the ferrite powder.

According to another embodiment of the present invention, there is provided multilayered chip components, including: a ferrite layer using a ferrite material comprising a ferrite powder having a core-shell structure, the core being made of iron (Fe) or iron-based compounds comprising iron (Fe) and the shell being made of metal oxides and glass; inner electrodes; and outer electrodes.

The glass may serve as a gap layer.

The inner electrodes and the outer electrodes may be made of Ag.

The ferrite layer may have magnetic permeability of 10 to 50 at 1 MHz.

The ferrite layer may have a saturation magnetization value of 100 emu to 250 emu/g.

The multilayered chip components may be one or more selected from the group consisting of a multilayered chip inductor, a multilayered chip bead, and a multilayered chip power inductor, but not be limited thereto.

### BRIEF DESCRIPTION OF THE DRAWINGS

FIG. 1 is a graph showing a change in an inductance value in response to applied current of a multilayered power inductor and a wound power inductor.

FIG. 2 shows the change in the inductance value of the multilayered power inductor using materials having high saturation magnetization (high Ms) and the multilayered power inductor using materials having low saturation magnetization (low Ms) in response to the applied current.

FIG. 3 is a diagram showing a structure of a general multilayered power inductor.

FIG. 4 is a diagram showing a structure of a ferrite power of metal having a core-shell structure according to an exemplary embodiment of the present invention.

FIG. 5 is a diagram showing results of X-ray diffraction of the ferrite power of metal having the core-shell structure according to the exemplary embodiment of the present invention.

FIG. 6 is a diagram showing a magnetic history curve of the ferrite power having a Fe—Fe₃O₄ core-shell structure according to Example 1 of the present invention and NiZnCu ferrite according to Comparative Example 1.

FIG. 7 shows an inductance value to a frequency of a toroidal core made of a ferrite material of Example 2.

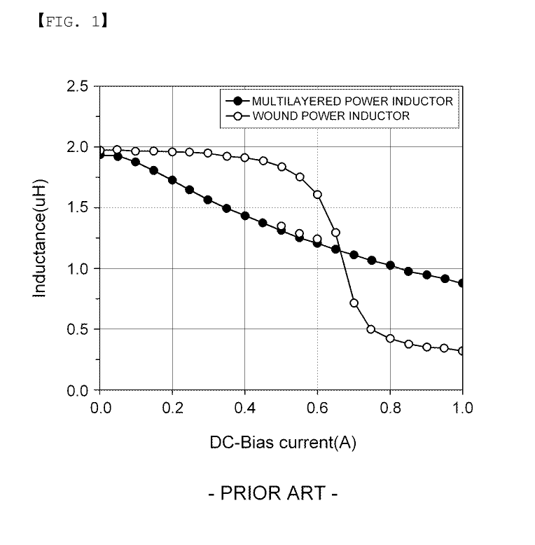

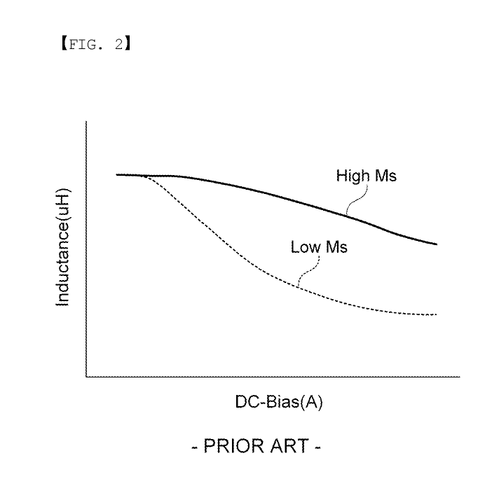

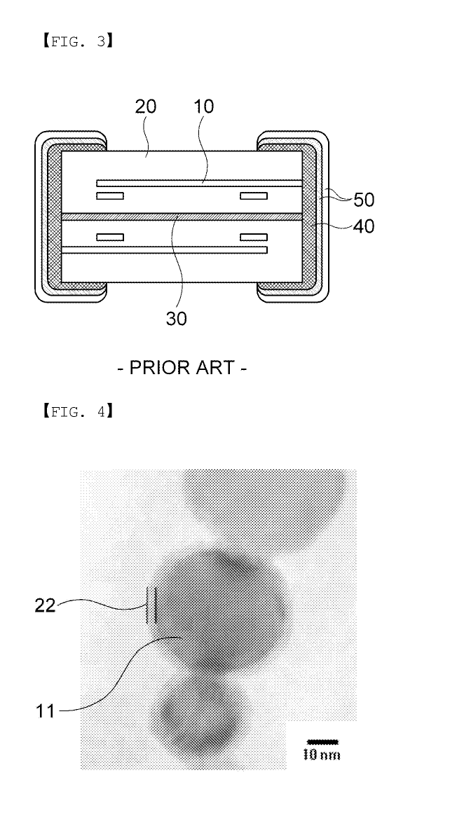

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Exemplary embodiments of the present invention relate to a ferrite powder used as a ferrite material forming a body of multilayered chip components, a ferrite material and a ferrite layer comprising the same, multilayered chip components including inner electrodes and outer electrodes.

### 1. Ferrite Powder

The ferrite powder according to the exemplary embodiment of the present invention has a core-shell structure, wherein the core is iron (Fe) metal or iron-based compounds comprising iron and the shell is made of metal oxides.

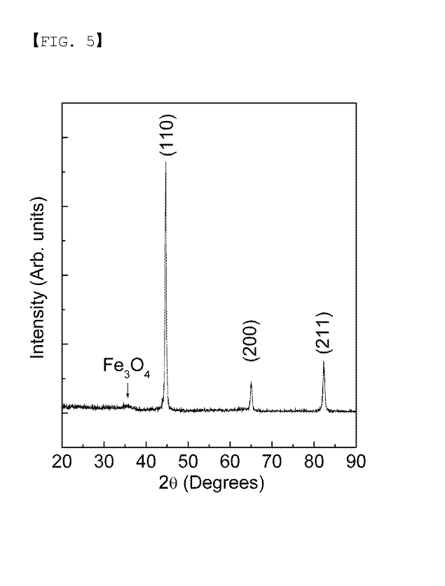

The ferrite powder according to the exemplary embodiments of the present invention has a structure shown in FIG. 4. Referring to FIG. 4, the ferrite powder has a core 11-shell 22 structure, wherein the core 11 may preferably use the iron-based compound comprising Fe metal or iron. The iron-based compounds may include Fe—Al—Si, Fe—Cr—Si, and the like, but the exemplary embodiment of the present invention is not limited thereto.

In addition, the shell 22 is metal oxides.

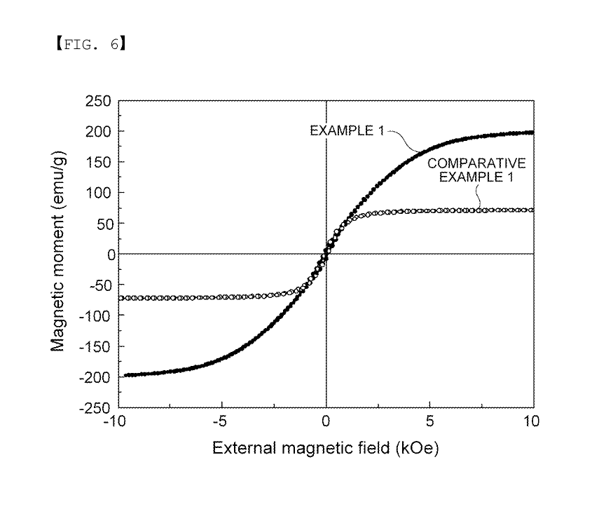

In addition, FIG. 5 shows results of X-ray diffraction of Fe—Fe₃O₄ metal powder as the example of the ferrite powder having the core-shell structure having the exemplary embodiment of the present invention, which can confirm peaks of the Fe metal forming the core and Fe₃O₄ metal oxide forming the shell.

The metal oxides forming the shell 22 of the ferrite powder having the core-shell structure according to the exemplary embodiment of the present invention may be one or more selected from the group consisting of TiO₂, SiO₂, ZrO₂, SnO₂, NiO, ZnO, CuO, CoO, MnO, MgO, Al₂O₃, Cr₂O₃, Fe₂O₃, B₂O₃, and Bi₂O₃, but the exemplary embodiment of the present invention is not limited thereto.

In the ferrite powder, the core is made of a content of 95 mol % of Fe metal and the shell is made of the rest.

The ferrite powder having the core-shell structure is prepared by reducing, filtering, washing, and drying materials forming the core using a liquid phase method and may be prepared by adding and coating shell forming materials thereto.

In addition, the ferrite powder may be prepared by reducing the core metal using the liquid phase method but the exemplary embodiment of the present invention is not limited thereto. There is a method of preparing the core metal by electrical explosion or plasma spraying and then, forming a slight oxide layer.

When the ferrite powder of metal is used as it is, the materials may be oxidized. In the exemplary embodiment of the present invention, it is possible to prevent metal from being oxidized by coating the outside thereof with iron (Fe) as metal oxides or iron-based compounds comprising iron. Therefore, they may be used as stable materials for the multilayered chip components.

### 2. Ferrite Material

The ferrite material according to the exemplary embodiment of the present invention has the core-shell structure and is made of glass and the ferrite powder in which the core is iron (Fe) or iron-based compounds comprising iron and the shell is made of metal oxides.

As the ferrite material used as a body material, NiZnCu ferrite is used, but in the exemplary embodiment of the present invention, the Fe ferrite powder having the core-shell structure is used. The ferrite powder according to the exemplary embodiment of the present invention is the same as the above description.

In addition, in order to the sinterability and isolation, a glass powder is used as additives.

The glass powder included in the ferrite material according to the exemplary embodiment of the present invention may preferably have a softening temperature Ts of 400 to 900° C. in the fact that the sinterability of the body material of the multilayered chip components can be improved and the isolating layer may be formed in a form surrounding the metal with the glass.

The ferrite material may preferably include 5 to 25 parts by weight of the glass for every 100 parts by weight of the ferrite powder. When the glass powder is below 5 parts by weight, the metal powders may be stuck to each other and may include 5 parts by weight or more in order to isolate the metal powders from each other. However, when the glass powder exceeds 25 parts by weight, magnetic permeability is reduced less than 10, such that it is difficult to implement inductance.

### 3. Multilayered Chip Components

The multilayered chip components according to the exemplary embodiment of the present invention have the core-shell structure, wherein the core is made of iron (Fe) or iron-based compounds comprising iron and the shell includes the ferrite powder made of the metal oxides, a ferrite layer using the ferrite material comprising the glass, the inner electrodes, and the outer electrodes.

In the exemplary embodiment of the present invention, the ferrite powder having the core-shell structure is used as the ferrite layer (body) and may instead perform a role of the non-ferrite gap layer using the glass that may isolate the ferrite powder.

In the multilayered chip components according to the exemplary embodiment of the present invention, it is preferable to use Ag as the inner electrodes and the outer electrodes in terms of temperature stability. However, only Ag is not used as the internal and outer electrodes.

The ferrite layer according to the exemplary embodiment of the present invention may preferably have the magnetic permeability of 10 to 50 at 1 MHz. The ferrite powder of Fe metal has a large magnetic permeability in a band of kHz and thus, cannot be easily used in a band of MHz. However, in the exemplary embodiment of the present invention, the ferrite powder can be used even in a band of MHz due to the mixing with the glass.

In addition, the ferrite layer may preferably have a saturation magnetization value of 100 emu to 250 emu/g. This has the saturation magnetization value two times higher than that of the ferrite material used in the related art and thus, the change rate in inductance after the external current is applied can be reduced.

The multilayered chip components according to the exemplary embodiment of the present invention may be used for various purposes of one or more selected from the group consisting of a multilayered chip inductor, a multilayered chip bead, and a multilayered chip power inductor, but the exemplary embodiment of the present invention is not limited thereto.

Hereinafter, preferred examples of the present invention will be described in detail. The following examples describe the present invention by way of example only and the scope of the present invention is not construed as being limited to the following examples. In addition, the following examples are described using specific compounds, but in even when equivalents thereof are used, it is apparent to those skilled in the art that the same or like effects are shown.

### EXAMPLE 1

### Preparation of Ferrite Powder of Metal Having Core-Shell Structure

The Fe core metal was prepared by reducing the Fe metal forming the core using the liquid phase method and then, performing the filtering, washing, and drying processes thereon. In this case, the ferrite powder of Fe—Fe₃O₄ metal having the core-shell structure was prepared by adding start materials of metal oxides thereto.

In the ferrite powder of metal, the core was made of a content of 95 wt % or more of Fe and the rest is made of Fe₃O₄.

### EXAMPLE 2

### Preparation of Ferrite Material

The ferrite material was prepared by a mixture of 20 parts by weight of glass powder (25 mol % SiO₂-30 mol % B₂O₃-2 mol % BaO-25 mol % Li₂O-10 mol % TiO₂-3 mol % Al₂O₃-5 mol % ZrO₂) for 100 parts by weight of the ferrite powder of Fe-Fe₃O₄ metal having the core-shell structure prepared according to Example 1.

### COMPARATIVE EXAMPLE 1

The existing ferrite powder of NiZnCu was used as the ferrite material.

### EXPERIMENTAL EXAMPLE 1

### Measurement of Saturation Magnetization Value

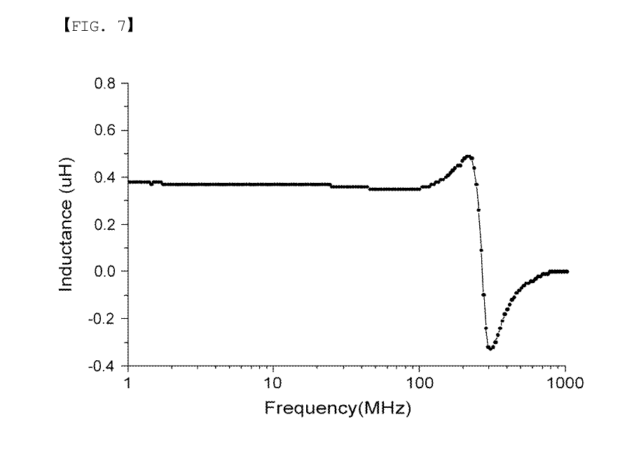

The saturation magnetization value of the metal powder was measured according to Example 1 and Comparative Example 1 and the results were shown in FIG. 6.

Next, as in the results of FIG. 6, the saturation magnetization value of the ferrite powder of Fe—Fe₃O₄ metal having the core-shell structure according to Embodiment of the present invention was about 200 emu/g and the saturation magnetization value of the ferrite powder of NiZnCu according to Comparative Example 1 was measured as about 65 emu/g. That is, it could be appreciated that the saturation magnetization value of the ferrite powder of Fe—Fe₃O₄ having the core-shell structure according to the exemplary embodiment of the present invention may be as larger as about three times. As a result, it could be derived that the ferrite powder has the high saturation magnetization value and therefore, the change rate in inductance after the external current is applied may be reduced.

### EXPERIMENTAL EXAMPLE 2

### Measurement of Magnetic Permeability

The toroidal core was manufactured using the ferrite material according to Example 2 of the present invention and the inductance value to the frequency thereof was measured. Thereafter, the measured results were shown in FIG. 7.

As in the results of FIG. 7, the initial magnetic permeability was measured as having a value of about 14. In addition, it could be confirmed that a self-resonance frequency (SRF) is 200 MHz or more and has the usable characteristic value in a band of MHz.

According to the exemplary embodiments of the present invention, it is possible to provide the ferrite material capable of improving the change in the inductance L value in response to applied current by suppressing magnetization at high current. The ferrite material according to the exemplary embodiments of the present invention can prevent the oxidization of the core metal, comprising the ferrite powder having the core-shell structure.

Further, the ferrite material according to the exemplary embodiments of the present invention includes the glass together with the ferrite power having the core-shell structure so as to serve the glass as the gap layer, thereby sufficiently obtaining the effect of the gap layer only by the mixing with the glass without adding the separate gap layer. The multilayered chip components comprising the ferrite material can also be used in a band of MHz.

Although the present invention has been shown and described with the exemplary embodiment as described above, the present invention is not limited to the exemplary embodiment as described above, but may be variously changed and modified by those skilled in the art to which the present invention pertains without departing from the scope of the present invention.

What is claimed is:

1. A ferrite powder having a core-shell structure, wherein the core is made of iron (Fe) or iron-based compounds comprising iron (Fe) and the shell is made of metal oxides.

2. The ferrite powder according to claim 1, wherein the metal oxides are one or more selected from the group consisting of TiO₂, SiO₂, ZrO₂, SnO₂, NiO, ZnO, CuO, CoO, MnO, MgO, Al₂O₃, Cr₂O₃, Fe₂O₃, B₂O₃, and Bi₂O₃.

3. The ferrite powder according to claim 1, wherein the core is made of a content of 95 mol % of Fe metal and the shell is made of the rest.

4. A ferrite material, comprising:
a ferrite powder having a core-shell structure, the core being made of iron (Fe) or iron-based compounds comprising iron (Fe) and the shell being made of metal oxides; and
glass.

5. The ferrite material according to claim 4, wherein the glass has a softening temperature Ts of 400 to 900° C.

6. The ferrite material according to claim 4, wherein it includes 5 to 25 parts by weight of the glass for 100 parts by weight of the ferrite powder.

7. Multilayered chip components, comprising:
a ferrite layer using a ferrite material comprising a ferrite powder having a core-shell structure, the core being made of iron (Fe) or iron-based compounds comprising iron (Fe) and the shell being made of metal oxides and glass;
inner electrodes; and
outer electrodes.

8. The multilayered chip components according to claim 7, wherein the glass serves as a gap layer.

9. The multilayered chip components according to claim 7, wherein the inner electrodes and the outer electrodes are made of Ag.

10. The multilayered chip components according to claim 7, wherein the ferrite layer has magnetic permeability of 10 to 50 at 1 MHz.

11. The multilayered chip components according to claim 7, wherein the ferrite layer has a saturation magnetization value of 100 emu to 250 emu/g.

12. The multilayered chip components according to claim 7, wherein the multilayered chip components are one or more selected from the group consisting of a multilayered chip inductor, a multilayered chip bead, and a multilayered chip power inductor.
